(19) United States
(12) Patent Application Publication
(10) Pub. No.: US 2011/0205175 A1
(43) Pub. Date: Aug. 25, 2011

(54) METHOD AND DEVICE FOR DETERMINING ROTATION GESTURE

(75) Inventor: JIA-MING CHEN, Taipei City (TW)

(73) Assignee: EGALAX_EMPIA TECHNOLOGY INC., Taipei City (TW)

(21) Appl. No.: 13/032,945

(22) Filed: Feb. 23, 2011

(30) Foreign Application Priority Data
Feb. 25, 2010 (TW) 099105385

(51) Int. Cl. G06F 3/033; G06F 3/041

(52) U.S. Cl. 345/173; 715/863

(57) ABSTRACT

The method and device for determining a rotation gesture are disclosed. By separating a touch trace into a plurality of segments, the orientation of each segment of the trace can be determined. According to these orientations, it can be determined whether the trace is a rotation gesture, and if so, the direction of the rotation gesture.

### BACKGROUND OF THE INVENTION

1. Field of the Invention

The present invention relates to a method and device for determining gestures on a touch pad, and more particularly, to a method and device for determining a rotation gesture on a touch pad.

2. Description of the Prior Art

Rotation gestures are often used in touch sensitive field. Each rotation gesture is mainly actuated by an arc touch trace, which is recognized by a controller or a processor to correspond to a particular command or to actuate a process.

One common type of rotation gesture is applied onto a particular touch sensitive track, that is, the touch sensitive track defines a predetermined region, along which a rotation gesture can be determined. For example, a circular region of a jog dial is shown in FIG. 12. When a finger moves along this circular region on the jog dial, a controller may determine a rotation gesture according to the positional information on the jog dial.

Furthermore, a rotation gesture can be made on a touch pad, which is determined based on the touch locations returned by the touch pad. Such application is not limited to any particular hardware or region, but can be applied to a touch screen, on which a gesture trace is shown at the same time the gesture is being made. This provides more intuitive use.

As shown in FIG. 13, a common method for determining a rotation gesture includes taking a first, a second and a third location on a touch trace, taking the length between the first and the second locations and the length between the second and the third locations as a first and a second line segment, respectively, and determining whether the gesture is a rotation gesture and, if so, its rotating direction based on the first and the second line segments. For example, when the angle a between the first and the second line segments is within a predetermined range, then the gesture is determined as a rotation gesture, and its rotating direction is also determined by the angle.

However, such method for determining a rotation gesture may limit the use of other gestures, causing great inconveniences. For example, two continuous line segments may be misinterpreted as a rotation gesture, but numerous gestures are composed of line segments, which may easily cause conflicts with rotation gestures. In order to avoid such conflicts, there is a need for a better method for determining a rotation gesture.

From the above it is clear that the conventional method for determining a rotation gesture still has shortcomings. In order to solve these problems, efforts have long been made in vain, while ordinary products and methods offering no appropriate structures and methods. Thus, there is a need in the industry for a novel method and device for determining a rotation gesture that solves these problems.

### SUMMARY OF THE INVENTION

An objective of the present invention is to determine a rotation gesture and its rotating direction according to the orientation of each segment that divides a touch trace, which solves the problem of the prior art in which rotation gesture is determined in such as way that a non-rotation gesture of two continuous segments is easily misjudged as a rotation gesture, since a rotation gesture is traditionally determined based on the angle between two segments formed between three points taken along the touch trace.

The objective of the present invention can be achieved by implementing the following technical scheme. According to a device for determining a rotation gesture, it may include: a memory for storing a rotation gesture determining program and a plurality of reference orientation ranges determined based on a clockwise or an anticlockwise direction; a coordinate input interface, including: a touch device for providing touch sensitive information; and a controller for generating a plurality of continuous coordinates based on the touch sensitive information; and a programmable processing unit for performing the following processes according to the rotation gesture determining program: generating a plurality of coordinate pairs from the continuous coordinates obtained by the coordinate input interface, wherein each coordinate pair includes a start coordinate and an end coordinate; determining an orientation of the start coordinate towards the end coordinate of each coordinate pair; and determining whether the continuous coordinates represent a rotation gesture by comparing the orientations of the coordinate pairs with the reference orientation ranges.

The objective of the present invention can be further achieved by implementing the following technical scheme.

The programmable processing unit may further perform the following processes according to the rotation gesture determining program: determining an orientation range of the reference orientation ranges to which the orientation of each coordinate pair correspond to generate a plurality of continuous orientation ranges; and determining whether the continuous coordinates represent a rotation gesture according to the continuous orientation ranges.

When the continuous orientation ranges are arranged in a clockwise direction with respect to the reference orientation ranges, the continuous coordinates represent a clockwise rotation gesture, and when the continuous orientation ranges are arranged in an anticlockwise direction with respect to the reference orientation ranges, the continuous coordinates represent an anticlockwise rotation gesture.

The programmable processing unit may further perform the following process according to the rotation gesture determining program: filtering or ignoring the orientation range that is the same as a previous orientation range in the continuous orientation ranges.

The programmable processing unit may further perform the following processes according to the rotation gesture determining program: filtering or ignoring the coordinate that is the same as a previous coordinate in the continuous coordinates; and pairing up to form the coordinate pairs based on the continuous coordinates with the coordinates that are the same as a previous coordinate filtered or ignored.

Each coordinate pair is paired up according to the following relationship between the start coordinate and the end coordinate: a time difference therebetween, a number of coordinates therebetween, or a distance therebetween.

Any two successive coordinate pairs have all different coordinates.

The orientation and the orientation range are represented by a slope, a vector, or an angle.

The programmable processing unit may further perform the following process according to the rotation gesture determining program: when the number of successive repeating orientation ranges in the continuous orientation ranges exceeding a threshold, then determining that the continuous coordinates do not represent the rotation gesture.

The objective of the present invention can be achieved by implementing the following technical scheme. According to a method for determining a rotation gesture, it may include: generating a plurality of coordinate pairs from a continuous coordinates obtained by a coordinate input interface, wherein each coordinate pair includes a start coordinate and an end coordinate; determining an orientation of the start coordinate towards the end coordinate of each coordinate pair; and determining a rotation gesture according to the orientations of the coordinate pairs.

The objective of the present invention can be further achieved by implementing the following technical scheme.

Any two successive coordinate pairs have all different coordinates.

The determining the rotation gesture may include: determining a plurality of orientation ranges according to a clockwise or an anticlockwise direction; determining an orientation range of the reference orientation ranges to which the orientation of each coordinate pair correspond to generate a plurality of continuous orientation ranges; and determining a rotation gesture according to the continuous orientation ranges and whether the rotation gesture is rotating clockwise or anticlockwise.

The method for determining a rotation gesture may further include: filtering or ignoring the orientation range that is the same as a previous orientation range in the continuous orientation ranges.

The rotation gesture is determined when the continuous orientation ranges are arranged in a clockwise or an anticlockwise direction.

The orientation and the orientation range are represented by a slope, a vector, or an angle.

The coordinate input interface may include: a touch device for providing touch sensitive information; and a controller for generating a plurality of continuous coordinates based on the touch sensitive information.

The method for determining a rotation gesture may further include: filtering or ignoring the coordinate that is the same as a previous coordinate in the continuous coordinates; and pairing up to form the coordinate pairs based on the continuous coordinates with the coordinates that are the same as a previous coordinate filtered or ignored.

Each coordinate pair is paired up according to the following relationship between the start coordinate and the end coordinate: a time difference therebetween, a number of coordinates therebetween, or a distance therebetween.

The method for determining a rotation gesture of claim may further include: when the number of successive repeating orientation ranges in the continuous orientation ranges exceeding a threshold, then determining that the continuous coordinates do not represent the rotation gesture.

The determining according to the orientations of the coordinate pairs may include determining the tendency of change of the coordinate pairs, and when the tendency of change of these coordinate pairs is clockwise or anticlockwise, a clockwise or anticlockwise rotation gesture is determined.

With the technical schemes above, the method and device for determining a rotation gesture have at least the following advantages and effects:
avoiding misjudging a touch trace composed of two segments as a rotation gesture in the prior art by segmenting a touch trace and representing segments in coordinate pairs and determining a rotation gesture based on the orientations of the segments;
easy determination of touch traces of non-rotation gestures when there are several successive coordinate pairs with the same orientation ranges; and
filtering of coordinate pairs with successive repeating coordinates and repeating orientation ranges, suitable for determining slower moving or slightly pausing rotation gestures.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 is a functional block diagram illustrating a pointing device of the present invention;

FIG. 2 is a functional block diagram illustrating a device for determining rotation gesture according to a first embodiment of the present invention;

FIGS. 3 to 5 are flowcharts illustrating a method for determining rotation gesture according to a second embodiment of the present invention;

FIGS. 6 to 8 are schematic diagrams showing reference orientation ranges of the present invention;

FIG. 9 is a schematic diagram showing a plurality of continuous coordinates;

FIG. 10 is a schematic diagram illustration determination of the orientations of coordinate pairs;

FIG. 11 is a schematic diagram showing a plurality of orientation ranges; and

FIGS. 12 and 13 are schematic diagrams of a prior art.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

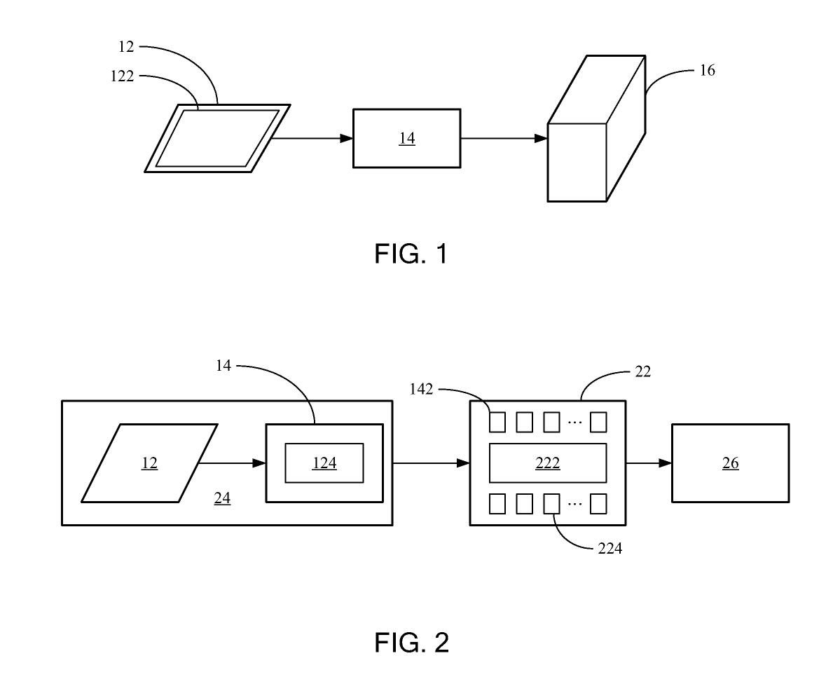

FIG. 1 is a functional block diagram illustrating a pointing device, which includes a touch device 12 and a controller 14. The touch device 12 includes a sensor 122, which can be a capacitive, a resistive, an optical, a SAW or a vibration sensor. The controller 14 can determine a touch location based on touch information provided by the sensor. The touch location corresponds to the sensor's native coordinates, which is related to the resolution of the sensor 122. In addition, the controller 14 can be connected to a host 16 with host coordinates. The controller can convert the native coordinates of the touch location into new values that correspond to the host coordinates and provide them to the host 16. The host 16 may include a display device disposed below the touch device 12, allowing a user to see the information on the display device via the touch device 12, thereby enabling interactions in conjunction with touch control. In an example of the present invention, the touch device 12 can accept more than one touch, and the controller 14 can process more than one touch in response to the touch device 12.

In a first embodiment of the present invention, a device for determining a rotation gesture includes a memory 22, a coordinate input interface 24, and a programmable processing unit 26, as shown in FIG. 2. The coordinate input interface 24 include the touch device 12 and the controller 14 just described, and the memory 22 and the programmable processing unit 26 may be included in the controller 14 or the host 16.

The touch device 12 can provide touch information 124. The controller 14 then generates a plurality of continuous coordinates 142 based on the touch information 124, and stores the plurality of continuous coordinates 142 in the memory 22. In addition, the memory 22 also stores a rotation gesture determining program 222 and a plurality of reference orientation ranges 224 determined according to a clockwise or an anticlockwise direction. These reference orientation ranges 224 can be stored in the memory 22 in the form of a lookup table, the data structures thereof are easily recognized by one with ordinary skill in the art. In addition, the programmable processing unit 26 determines whether these continuous coordinates 142 represent a rotation gesture according to the rotation gesture determining program 222 and with reference to the reference orientation ranges 224. In an example of the present invention, the programmable processing unit 26 is built into the controller 14, and the continuous coordinates 142 are native coordinates described before. In another example of the present invention, the programmable processing unit 26 is built into the host 16, and the continuous coordinates 142 are host coordinates described before. In other words, determination of a rotation gesture is performed at the host 16, or alternatively at the controller 14 and the host 16 is informed once a rotation gesture is determined.

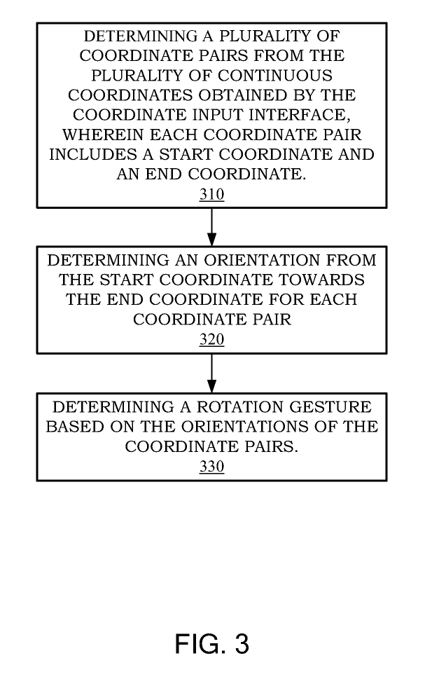

According to a second embodiment of the present invention, a method for determining a rotation gesture is shown in FIG. 3. In step 310, a plurality of coordinate pairs are determined from the plurality of continuous coordinates 142 obtained by the coordinate input interface 24, wherein each coordinate pair includes a start coordinate and an end coordinate. Next, in step 320, an orientation from the start coordinate towards the end coordinate is determined for each coordinate pair, and in step 330, a rotation gesture is determined based on the orientations of the coordinate pairs.

In an example of the present invention, the coordinates in each coordinate pair do not overlap each other. For example, the continuous coordinates 142 are (X1,Y1), (X2,Y2), (X3,Y3), (X4,Y4), (X5,Y5), (X6,Y6) and so on, and each coordinate pair is ((X1,Y1),(X2,Y2)),((X3,Y3),(X4,Y4)), and so on. That is, each coordinate pair is formed by two sequential coordinates.

In another example of the present invention, in the continuous coordinates 142, at least one coordinate is located between the start and ending coordinates. For examples, ach coordinate pair may be ((X1,Y1),(X3,Y3)), ((X4,Y4),(X6,Y6)), and so on, or ((X1,Y1),(X3,Y3)), ((X2,Y2),(X4,Y4)), and so on; one with ordinary skill in the art may appreciate other types of pairing for the coordinates.

In the present invention, a coordinate pair can be paired up according to the following relationships: a time difference therebetween, a number of coordinates therebetween, or a distance therebetween. That is, the pairing can be performed at the same time or after the coordinates are generated at a fixed interval or a fixed quantity, or the pairing can be performed based on a horizontal distance therebetween, a vertical distance therebetween, or whether a distance therebetween exceeds a distance threshold. The present invention includes, but is not limited to, the above relationships; one with ordinary skill in the art may appreciate other pairing relationships.

The present invention includes, but is not limited to, overlap of coordinates among coordinate pairs, for example, ((X1,Y1),(X3,Y3)) and ((X3,Y3),(X6,Y6)). That is, the end coordinate of one pair may be the start coordinate of the other pair.

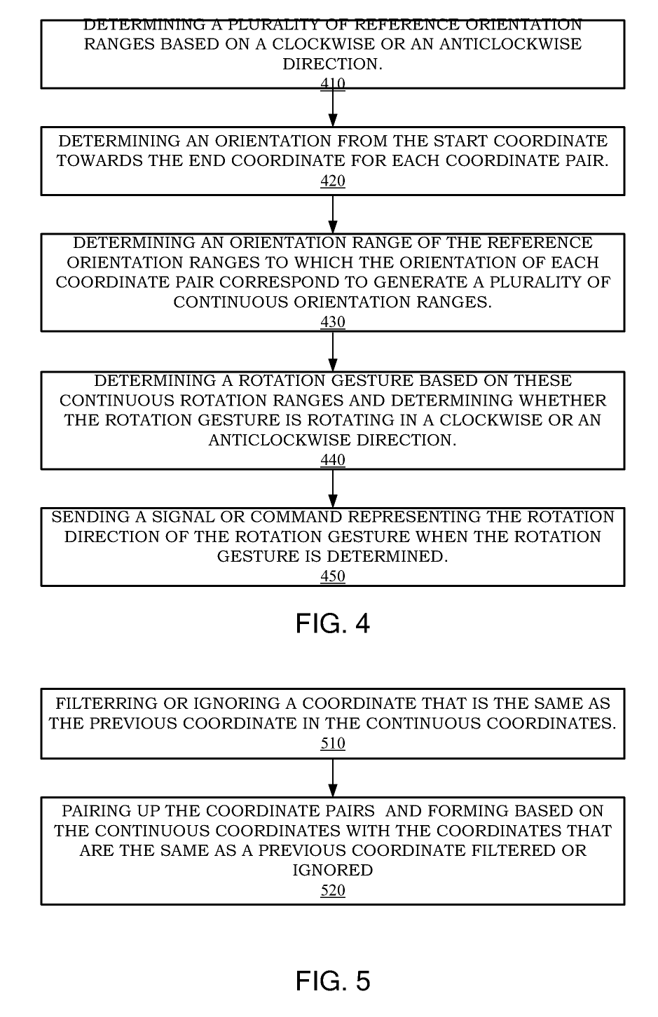

The determination of a rotation gesture described above is shown in FIG. 4. First, in step 410, a plurality of reference orientation ranges are determined based on a clockwise or an anticlockwise direction, such as the above reference orientation ranges 224 determined based on a clockwise or an anticlockwise direction stored in the memory 22. In addition, in steps 420 and 430, an orientation from the start coordinate towards the end coordinate for each coordinate pair is determined, and then an orientation range of the reference orientation ranges to which the orientation of each coordinate pair correspond is determined to generate a plurality of continuous orientation ranges. Moreover, in step 440, a rotation gesture is determined based on these continuous rotation ranges and the direction of the rotation (clockwise or anticlockwise) is also determined, that is, a clockwise rotation gesture or an anticlockwise rotation gesture is determined. Finally, in step 450, when the rotation gesture is determined, a signal or command representing the rotation direction of the rotation gesture is sent.

Each of these orientation ranges defines an orientation zone, and is arranged sequentially in a clockwise or anticlockwise direction. In an example of the present invention, these orientation ranges evenly divides 360 degrees. In another example of the present invention, one orientation range may partially overlap another orientation range. In yet another example of the present invention, adjacent orientation ranges may be spaced by an angle. These orientation ranges or the data structure thereof stored in the memory can be presented as slope ranges, vector ranges, angular ranges and the like; one with ordinary skill in the art may appreciate other types of representations.

In addition, the plurality of orientation ranges determined based on a clockwise or an anticlockwise direction can be a set of orientation ranges arranged in a clockwise direction, a set of orientation ranges arranged in an anticlockwise direction, or two sets of orientation ranges determined based on the clockwise and the anticlockwise directions, respectively.

As such, in step 430, a reference orientation range to which the orientation of each coordinate pair corresponds can be determined by looking up in a table or comparing one by one, so as to generate the continuous orientation ranges. Further, as shown in step 440, when the continuous orientation ranges are arranged in a clockwise direction with respect to the reference orientation ranges, a clockwise rotation gesture is determined. On the contrary, when the continuous orientation ranges are arranged in an anticlockwise direction with respect to the reference orientation ranges, an anticlockwise rotation gesture is determined. Then, as shown in step 450, a corresponding signal or command representing the rotation gesture is sent based on the determined rotation gesture.

When a touch object move more slowly, or the area defined by the orientation range is larger, these continuous orientation ranges may have repeating orientation ranges. Accordingly, the present invention further includes a step of filtering or ignoring an orientation range that is the same as the previous orientation ranges in the continuous orientation ranges. Moreover, the touch object may pause for a while, causing repeating coordinates to occur in the continuous coordinates. The present invention is further shown in steps 510 and 520 of FIG. 5, in which a coordinate that is the same as the previous coordinate in the continuous coordinates is filtered or ignored, and the coordinate pairs are paired up and formed based on the continuous coordinates with the coordinates that are the same as a previous coordinate filtered or ignored.

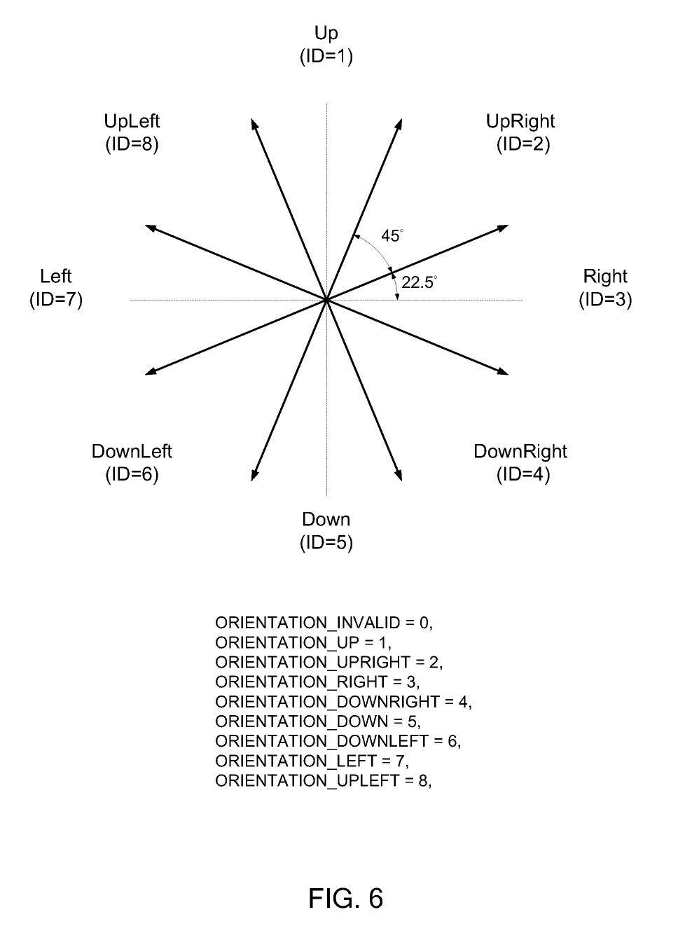

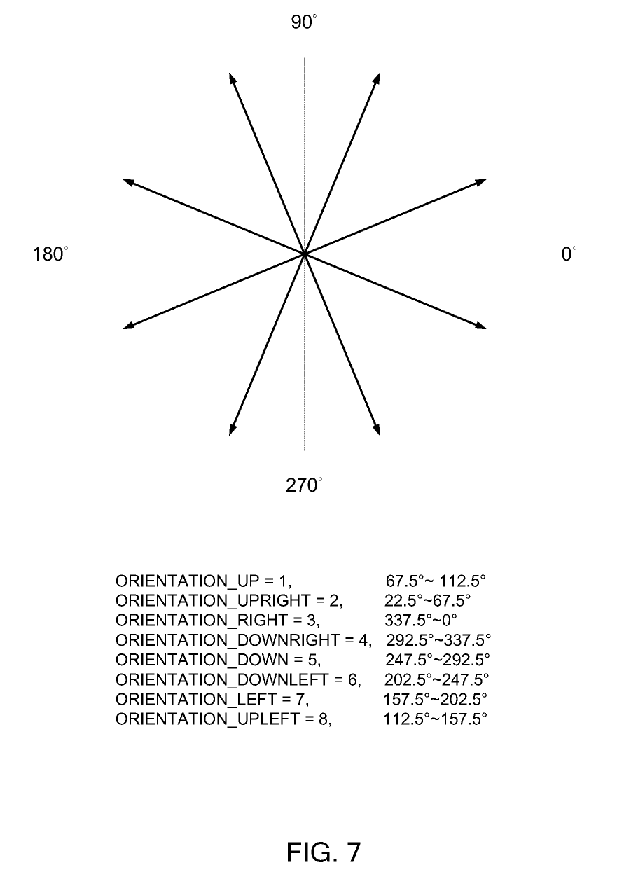

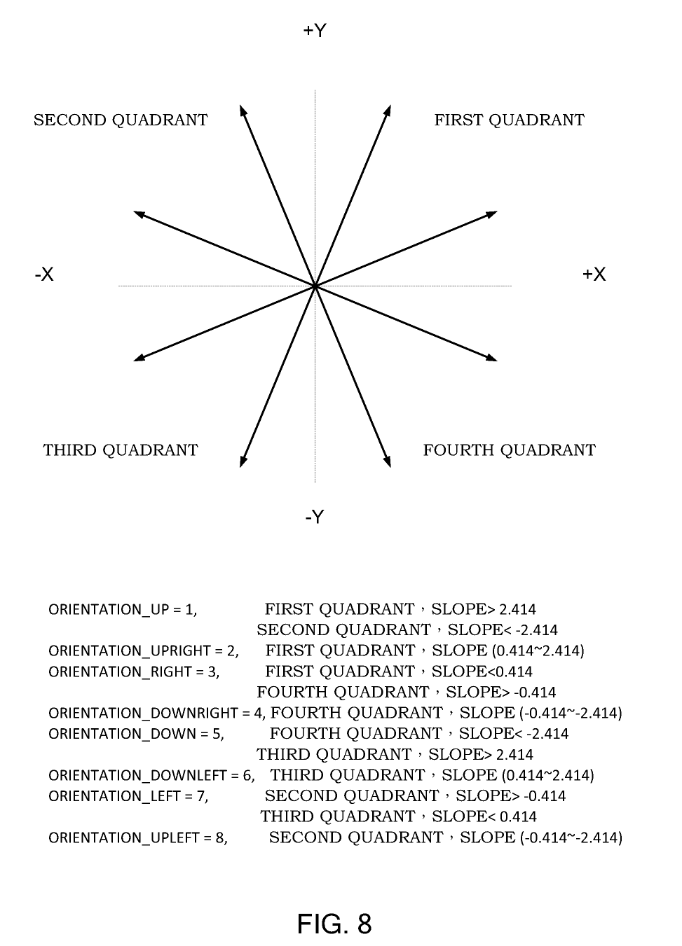

In an example of the present invention, there are eight reference orientation ranges as shown in FIG. 6, they are: ORIENTATION_UP, ORIENTATION_UPRIGHT, ORIENTATION_RIGHT, ORIENTATION_DOWNRIGHT, ORIENTATION_DOWN, ORIENTATION_DOWNLEFT, ORIENTATION_LEFT, and ORIENTATION_UPLEFT; representing up, up right, right, down right, down, down left, left, and up left orientations and numbered 1 to 8, respectively. The orientation ranges can be indicated by angles as shown in FIG. 7, or by vectors and slopes as shown in FIG. 8.

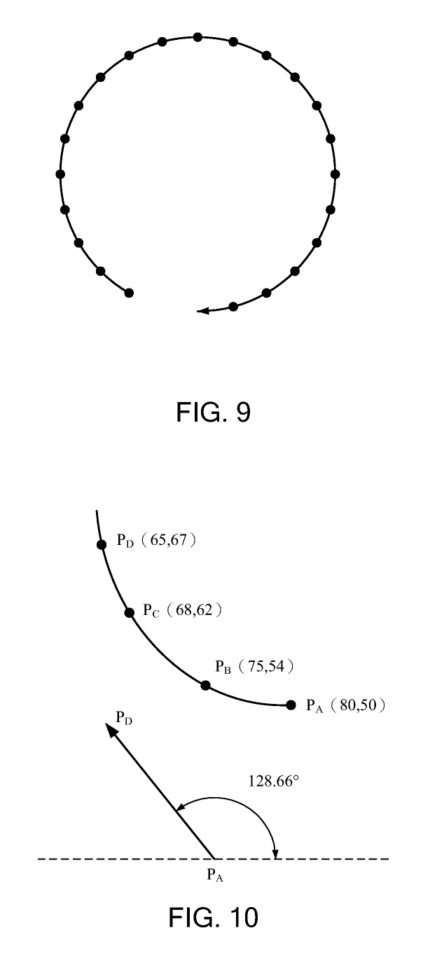

For example, a plurality of continuous coordinates 142 is obtained by the coordinate input interface 24 as shown in FIG. 9, wherein the first few coordinates P_{A}, P_{B}, P_{C}, and P_{D} are shown in FIG. 10. Assuming the first coordinate pair is (P_{A},P_{B}), which is 128.6° as represented by angles, and (−5, 4) as represented by vectors (dx, dy), and the slop is −0.8.

Referring to FIG. 7, angle 128.6° corresponds to an up left orientation (ORIENTATION_UPLEFT), numbered as 8. Thus, the orientation range of the orientation of the first coordinate pair is up left or 8. Similarly, referring to FIG. 8, vector (−5, 4) corresponds to the second quadrant, and with a slope of −0.8, the orientation range of the orientation of the first coordinate pair is thus up left or 8

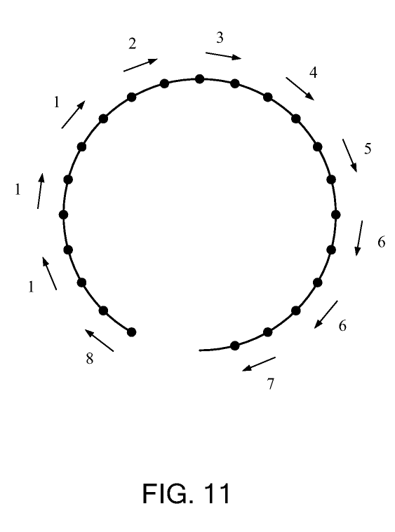

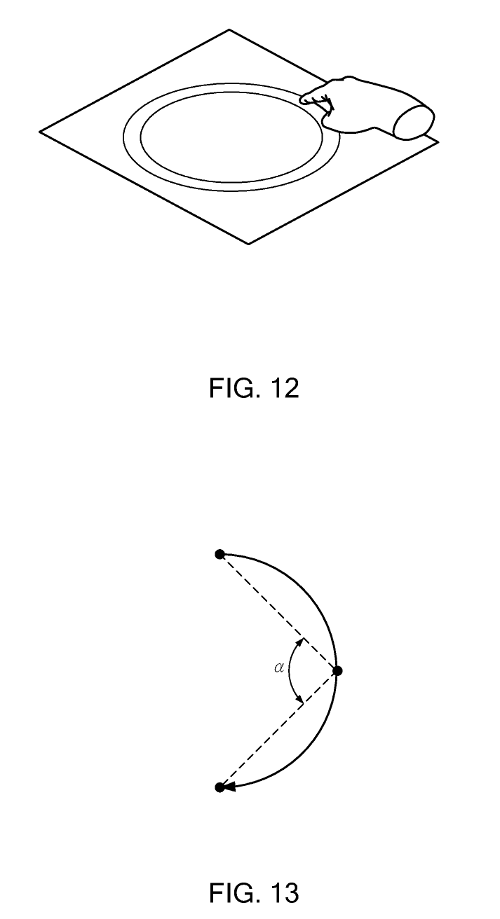

Furthermore, the second coordinate pair can be (P_{C} [symbol] P_{D}), the orientation range of its orientation is up (ORIENTATION_UP) or 1. The same applies for the other coordinate pairs. As shown in FIG. 11, the orientation ranges obtained are 8→1→1→1→2→3→4→5→6→6→7, respectively. If successively repeating orientation ranges are filtered or ignored, then the orientation ranges are 8→1→2→3→4→5→6→7. According to the reference orientation ranges, the entire or part of these orientation ranges can be used to infer that they are arranged in a clockwise direction, so it can be determined that the coordinates represent a rotation gesture rotating in a clockwise direction.

In other words, the above determination of the orientations of the coordinate pairs is based on the tendency of change of the coordinate pairs. When the tendency of change of these coordinate pairs is clockwise or anticlockwise, a clockwise or anticlockwise rotation gesture is determined.

Moreover, the continuous coordinates 142 may be a plurality of continuous coordinates 142 obtained after coordinates that are the same as their previous one are filtered. In addition, if the total number of the same orientation range occurs successively exceeds a threshold, then it is determined that the continuous coordinates to which these orientation ranges correspond does not represent a rotation gesture. This threshold may, for example, be 4.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A device for determining a rotation gesture, comprising:
a memory for storing a rotation gesture determining program and a plurality of reference orientation ranges determined based on a clockwise or an anticlockwise direction;
a coordinate input interface, comprising:
a touch device for providing touch sensitive information; and
a controller for generating a plurality of continuous coordinates based on the touch sensitive information; and
a programmable processing unit for performing the following processes according to the rotation gesture determining program:
generating a plurality of coordinate pairs from the continuous coordinates obtained by the coordinate input interface, wherein each coordinate pair includes a start coordinate and an end coordinate;
determining an orientation of the start coordinate towards the end coordinate of each coordinate pair; and
determining whether the continuous coordinates represent a rotation gesture by comparing the orientations of the coordinate pairs with the reference orientation ranges.

2. The device for determining a rotation gesture of claim 1, wherein the programmable processing unit further performs the following processes according to the rotation gesture determining program:
determining an orientation range of the reference orientation ranges to which the orientation of each coordinate pair correspond to generate a plurality of continuous orientation ranges; and
determining whether the continuous coordinates represent a rotation gesture according to the continuous orientation ranges.

3. The device for determining a rotation gesture of claim 2, wherein when the continuous orientation ranges are arranged in a clockwise direction with respect to the reference orientation ranges, the continuous coordinates represent a clockwise rotation gesture, and when the continuous orientation ranges are arranged in an anticlockwise direction with respect to the reference orientation ranges, the continuous coordinates represent an anticlockwise rotation gesture.

4. The device for determining a rotation gesture of claim 2, wherein the programmable processing unit further performs the following process according to the rotation gesture determining program:
filtering or ignoring the orientation range that is the same as a previous orientation range in the continuous orientation ranges.

5. The device for determining a rotation gesture of claim 2, wherein the programmable processing unit further performs the following processes according to the rotation gesture determining program:
filtering or ignoring the coordinate that is the same as a previous coordinate in the continuous coordinates; and
pairing up to form the coordinate pairs based on the continuous coordinates with the coordinates that are the same as a previous coordinate filtered or ignored.

6. The device for determining a rotation gesture of claim 5, wherein each coordinate pair is paired up according to the following relationship between the start coordinate and the end coordinate: a time difference therebetween, a number of coordinates therebetween, or a distance therebetween.

7. The device for determining a rotation gesture of claim 1, wherein any two successive coordinate pairs have all different coordinates.

8. The device for determining a rotation gesture of claim 1, wherein the orientation and the orientation range are represented by a slope, a vector, or an angle.

9. The device for determining a rotation gesture of claim 1, wherein the programmable processing unit further performs the following process according to the rotation gesture determining program:
when the number of successive repeating orientation ranges in the continuous orientation ranges exceeding a threshold, then determining that the continuous coordinates do not represent the rotation gesture.

10. A method for determining a rotation gesture, comprising:
generating a plurality of coordinate pairs from a continuous coordinates obtained by a coordinate input interface, wherein each coordinate pair includes a start coordinate and an end coordinate;
determining an orientation of the start coordinate towards the end coordinate of each coordinate pair; and
determining a rotation gesture according to the orientations of the coordinate pairs.

11. The method for determining a rotation gesture of claim 10, wherein any two successive coordinate pairs have all different coordinates.

12. The method for determining a rotation gesture of claim 10, wherein the determining the rotation gesture includes:
determining a plurality of orientation ranges according to a clockwise or an anticlockwise direction;
determining an orientation range of the reference orientation ranges to which the orientation of each coordinate pair correspond to generate a plurality of continuous orientation ranges; and
determining a rotation gesture according to the continuous orientation ranges and whether the rotation gesture is rotating clockwise or anticlockwise.

13. The method for determining a rotation gesture of claim 12, further comprising:
filtering or ignoring the orientation range that is the same as a previous orientation range in the continuous orientation ranges.

14. The method for determining a rotation gesture of claim 12, wherein the rotation gesture is determined when the continuous orientation ranges are arranged in a clockwise or an anticlockwise direction.

15. The method for determining a rotation gesture of claim 12, wherein the orientation and the orientation range are represented by a slope, a vector, or an angle.

16. The method for determining a rotation gesture of claim 10, wherein the coordinate input interface includes:
a touch device for providing touch sensitive information; and
a controller for generating a plurality of continuous coordinates based on the touch sensitive information.

17. The method for determining a rotation gesture of claim 16, further comprising:
filtering or ignoring the coordinate that is the same as a previous coordinate in the continuous coordinates; and
pairing up to form the coordinate pairs based on the continuous coordinates with the coordinates that are the same as a previous coordinate filtered or ignored.

18. The method for determining a rotation gesture of claim 17, wherein each coordinate pair is paired up according to the following relationship between the start coordinate and the end coordinate: a time difference therebetween, a number of coordinates therebetween, or a distance therebetween.

19. The method for determining a rotation gesture of claim 12, further comprising:
when the number of successive repeating orientation ranges in the continuous orientation ranges exceeding a threshold, then determining that the continuous coordinates do not represent the rotation gesture.

20. The method for determining a rotation gesture of claim 10, wherein determining according to the orientations of the coordinate pairs includes determining the tendency of change of the coordinate pairs, and when the tendency of change of these coordinate pairs is clockwise or anticlockwise, a clockwise or anticlockwise rotation gesture is determined.
